(19) United States
(12) Patent Application Publication
(10) Pub. No.: US 2004/0134161 A1
(43) Pub. Date: Jul. 15, 2004

(54) System and method for strengthening towers

(76) Inventors: James D. Lockwood, Boulder, CO (US); David W. Hawkins, Dublin, OH (US)

Correspondence Address: McCormick, Paulding & Huber LLP, CityPlace II, 185 Asylum Street, Hartford, CT, 06103-3402, US

(21) Appl. No.: 10/685,780

(22) Filed: Oct. 15, 2003

Related U.S. Application Data
(60) Provisional application No. 60/419,188, filed on Oct. 17, 2002.

(51) Int. Cl. E04B 2/00; E04F 13/00; B32B 7/08; E02D 27/42; E04H 12/00; E04C 3/30

(52) U.S. Cl. 52/736.1; 156/92; 156/71; 52/170; 52/651.01

(57) ABSTRACT

A system and method of strengthening members of a tower comprises providing a tower including at least one tower member, and at least one reinforcing member. A structural adhesive is applied to the tower members and the reinforcing members. The reinforcing members are placed against corresponding tower members. The structural adhesive is cured to thereby permanently attach the reinforcing members to the tower members. The reinforcing members are secured to the corresponding tower members preferably by bolts while the structural adhesive is curing.

### CROSS REFERENCE TO RELATED APPLICATION

This application claims the benefit of U.S. Provisional Application Serial No. 60/419,188 filed on Oct. 17, 2002 entitled “A Method for Strengthening Steel Towers”, the disclosure of which is incorporated by reference herein in its entirety.

### FIELD OF THE INVENTION

This invention relates generally to structural reinforcement systems, and more particularly relates to a system and method for strengthening towers.

### BACKGROUND OF THE INVENTION

Existing methods of reinforcing steel towers require bolting or welding of heavy steel members which are difficult to position and install. When existing steel is galvanized, welding can often damage the galvanizing at locations that are not practical to repair later. When bolting is used, high clamping forces are necessary to provide sufficient friction between the tower and the new reinforcing member to transfer the shear forces between them. The present invention utilizes structural adhesives to transfer the shear forces between the tower and new reinforcing member, eliminating the need for welding or clamping. The invention utilizes bolts to position and support the new reinforcing member while the structural adhesive is cured.

The elimination of welding and friction clamping in the field provides cost savings in labor and time. Eliminating field welding also removes the risk of welding sparks dropping onto areas away from the tower and causing damage to property.

The completed retrofit reinforcement is low profile, meaning that no major projections exist from the tower when the retrofit work is complete. In addition to the aerodynamic advantages, this has benefits to tower owners and local communities who have aesthetic concerns about the appearance of their towers.

Accordingly, it is a general object of the present invention to overcome the above-identified drawbacks of prior systems and methods for strengthening towers.

### SUMMARY OF THE INVENTION

In one aspect of the present invention, a method of strengthening members of a tower comprises the steps of providing a tower including at least one tower member, and providing at least one reinforcing member. A structural adhesive is applied to at least one of the tower member and the reinforcing member. The reinforcing member is placed against the tower member. The structural adhesive is cured to thereby permanently attach the reinforcing member to the tower member. The reinforcing member is secured to the tower member while the structural adhesive is curing.

In another aspect of the present invention, a tower reinforcement system comprises a tower including at least one tower member. At least one reinforcing member is coupled to the at least one tower member by structural adhesive. At least one elongated fastener secures the reinforcing member to the tower member while the structural adhesive is curing.

### BRIEF DESCRIPTION OF THE DRAWINGS

FIG. 1 is a side cross-sectional view of a flat plate reinforcement coupled to a tower shaft in accordance with the present invention.

FIG. 2 is a side cross-sectional view of a channel reinforcement coupled to a tower shaft in accordance with the present invention.

FIG. 3 is a side cross-sectional view of a structural tube reinforcement coupled to a tower shaft in accordance with the present invention.

FIG. 4 is an elevational view of the channel reinforcement of FIG. 2 coupled to a tower shaft.

### DETAILED DESCRIPTION OF THE PREFERRED EMBODIMENTS

With reference to FIG. 1, a tower section that is reinforced in accordance with the present invention is indicated generally by the reference number 10. The reinforcement may be used for increasing the axial load carrying capacity of a tower structure or increasing the buckling capacity by making the tower structure more compact. The tower section 10 includes a tower member or shaft 12 having a flat plate reinforcement 14 coupled thereto for structural reinforcement of the shaft. The shaft 12 as shown is polygonal monopole in configuration, but may take other practical forms. The shaft 12 or other tower structure member is preferably made of a metal such as steel, but may be fabricated from other relatively strong and durable materials without departing from the scope of the present invention. As shown in FIG. 1, a structural adhesive 16 is interposed between the tower shaft 12 and the flat plate reinforcement 14 for attaching the flat plate reinforcement to the shaft. A clamp/shear bolt 18 or other elongated fastener temporarily secures the flat plate reinforcement 14 to the tower shaft 12 while the structural adhesive 16 is curing. The shape of the flat plate reinforcement 14 limits the aerodynamic drag on the tower shaft 12 when installed thereto, and increases the available surface area to bond the flat plate reinforcement to the tower shaft using the structural adhesive 16.

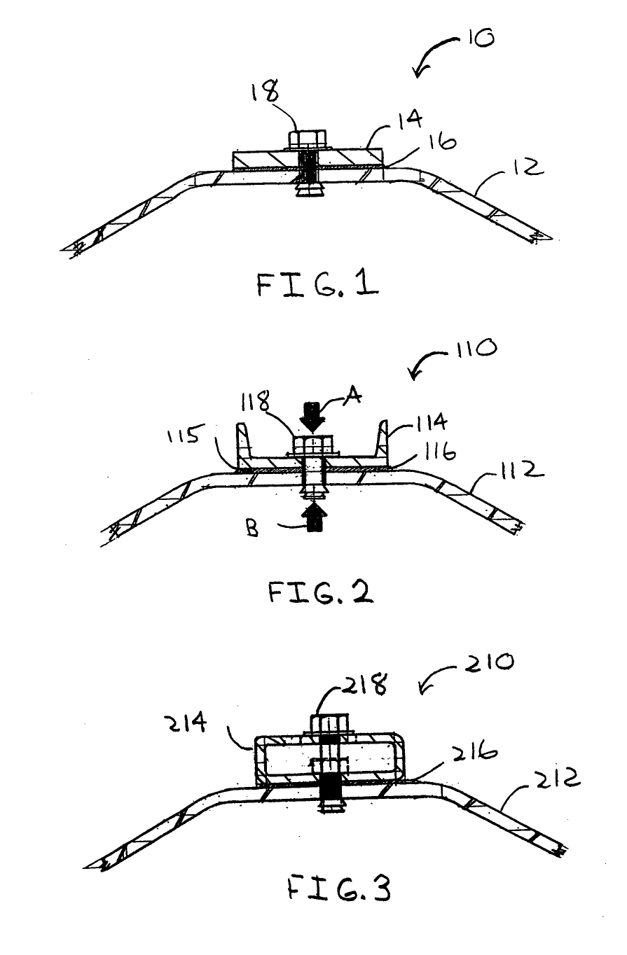

With reference to FIG. 2, a tower section that is reinforced in accordance with another embodiment of the present invention is indicated generally by the reference number 110. Like elements with the previous embodiment are indicated by like reference numbers preceded by “1”. The tower section 110 includes a tower shaft 112 having a channel reinforcement 114 coupled thereto for structural reinforcement of the shaft. As shown in FIG. 2, a structural adhesive 116 is interposed between the tower shaft 112 and the channel reinforcement 114 for attaching the channel reinforcement to the shaft. An outside flat face 115 of the channel reinforcement 114 is bonded to the tower shaft 112. A bolt 118 or other elongated fastener temporarily secures the channel reinforcement 114 to the tower shaft 112 while the structural adhesive 116 is curing.

With reference to FIG. 3, a tower section that is reinforced in accordance with yet another embodiment of the present invention is indicated generally by the reference number 210. Like elements with the previous embodiments are indicated by like reference numbers preceded by “2”. The tower section 210 includes a tower shaft 212 having a structural tube reinforcement 214 coupled thereto for structural reinforcement of the shaft. As shown in FIG. 3, a structural adhesive 216 is interposed between the tower shaft 212 and the structural tube reinforcement 214 for attaching the structural tube reinforcement to the shaft. A bolt 218 or other elongated fastener temporarily secures the structural tube reinforcement 214 to the tower shaft 212 while the structural adhesive 216 is curing. The bolt 218 can be fastened to either the outside of the structural tube reinforcement 214 as shown in solid form, or fastened to the inside of the structural tube reinforcement as shown in phantom form.

Reinforcement members such as the flat plate reinforcement 14 of FIG. 1, the channel reinforcement 114 of FIG. 2, and the structural tube reinforcement 214 of FIG. 3 are preferably fabricated from metallic materials, or fiber reinforced polymer (FRP) materials. FRP materials can include, for example, carbon fibers encapsulated in a resin matrix. However, the reinforcing members can be fabricated from other strong, durable and adherable materials without departing from the scope of the present invention. Moreover, the geometry of the reinforcing members can take other shapes depending on the availability and efficiency of the reinforcement shape.

In operation, the reinforcing members are adhered to a tower shaft using conventional structural adhesives. The reinforcing members are held in place during installation using bolts that can be installed from one side of the tower shaft. The purpose of these bolts is to transfer the weight of the reinforcing member to the tower structure—rather than to the adhesive—during the time the adhesive is curing. The bolts extend through drilled holes in the reinforcing member and the tower structure. The load transfer is one of shear placed into the bolt to transfer the weight of the reinforcing member onto the tower shaft.

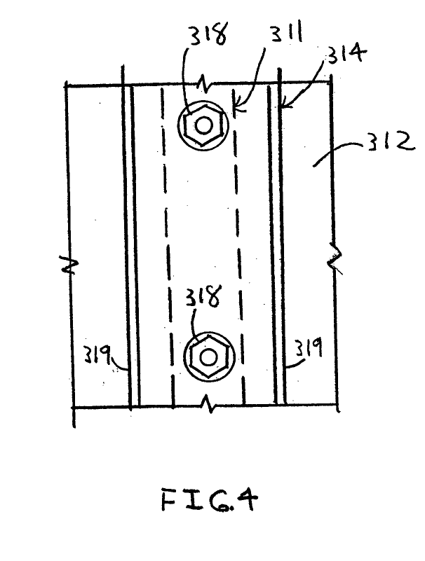

A secondary purpose of the bolts is to provide a means of applying pressure from the reinforcing member and the tower shaft to the structural adhesive. As shown in FIG. 2, for example, the direction of pressure exerted by the channel reinforcement 114 to the structural adhesive 116 is indicated by the arrow A, and the direction of pressure exerted by the tower shaft 112 to the structural adhesive is indicated by the arrow B. This allows the contractor to gauge the bond line thickness of the adhesive between the reinforcing member and the tower structure. To provide additional accuracy in ensuring an accurate bond line thickness, a spacer made of plastic, string or metal can be placed behind the reinforcing member prior to tightening the bolts. As shown in FIG. 4, for example, a spacer 311 is interposed between a channel reinforcement 314 and a section of a shaft 312. Bolts 318 are periodically located along the shaft 312 during curing of the structural adhesive. The location of the bolts 318 can be varied toward edges 319 of the reinforcement member in order to increase edge clamping.

The bolts are typically installed from one side only, unless sufficient space exists to access both sides. A representative bolt type used when access for bolting is limited to one side of a structure is the Hollo-Bolt™, manufactured by Lindapter North America in Ann Arbor, Mich. These bolts are installed from outside through holes in the reinforcing member and the tower shaft. The holes may be pre-drilled or drilled in the field. A practical solution is to pre-drill the hole in the reinforcing member and drill the hole in the tower shaft in the field.

The structural adhesive is placed between the surface of the reinforcing member and the tower shaft. The structural adhesive can be placed onto the reinforcing member itself prior to placing onto the tower shaft, or can be placed directly onto the tower shaft prior to pressing the reinforcing member onto the shaft. The structural adhesive is the primary means of transferring loads between the reinforcing member and the tower shaft. The loads are transferred in shear.

The tower structures that are reinforced can include, for example, monopole towers which are tapered and have multiple flat sides, and lattice towers which have multiple structural members to comprise the structure. On a monopole tower, the reinforcing provides local structural capacity to a flat and global structural capacity to the monopole's behavior. With respect to a lattice tower structure, the structural upgrade is localized to a member and affects the global behavior when multiple members are reinforced.

The reinforcing members are cut to their correct lengths prior to delivery to the site or field cut. When the reinforcing member is made of an FRP material, the inside surface of the member is sanded or surface prepared in the molding to ensure a good bond transfer between the FRP and adhesive. When the reinforcing member is steel and hot dip galvanized, a surface preparation of the side to receive the adhesive may be required. Depending on the quality of the galvanizing and its bond to the steel, this surface preparation may entail cleaning and etching (chemical or abrasive) or removing the galvanizing layer altogether. When available, a primer may be applied to the bare steel after it has been exposed to reduce the amount of oxidation that will begin to occur.

With the reinforcing members on site, the existing tower members to be reinforced are prepared for the adhesive by sanding, sandblasting or a chemical wash. Adhesive is next placed onto the surface and a spacer material can be placed on the adhesive. In lieu of spacer materials placed on the adhesive in the field, glass beads having the proper diameter may be mixed in with the adhesive at the time of mixing the adhesive components. The reinforcing members are then lifted into position and pressed onto the tower members. Once installed, the bolts are placed and used to position and press the reinforcing members.

The present invention utilizes structural adhesives to transfer the shear forces between the tower member and the new reinforcing member, eliminating the requirement for permanent welding or clamping. The elimination of welding and friction clamping in the field provides cost savings in labor and time. Eliminating field welding removes the risk of welding sparks dropping onto areas away from the tower and causing damage to property. It also eliminates welding damage to the galvanizing layer that exists on the inside of a tower member when welded to the outside of the member.

The completed retrofit reinforcement is low profile—meaning that no major projections exist from the tower when the retrofit work is complete. In addition to the aerodynamic advantages, this has benefits to tower owners and local communities who have aesthetic concerns about the appearance of their towers.

As will be recognized by those of ordinary skill in the pertinent art, numerous modifications and substitutions may be made to the above-described embodiments of the present invention without departing from the scope of the invention. Accordingly, the preceding portion of this specification is to be taken in an illustrative, as opposed to a limiting sense.

What is claimed is:

1. A method of strengthening members of a tower, comprising the steps of:
providing a tower including at least one tower member;
providing at least one reinforcing member;
applying structural adhesive to at least one of the at least one tower member and the at least one reinforcing member;
placing the at least one reinforcing member against the at least one tower member;
curing the structural adhesive to thereby permanently attach the at least one reinforcing member to the at least one tower member; and
securing the at least one reinforcing member to the at least one tower member while the structural adhesive is curing.

2. A method as defined in claim 1, wherein the step of securing includes applying bolts to the at least one reinforcing member and the at least one tower member.

3. A method as defined in claim 2, further including the step of removing the bolts from the at least one reinforcing member and the at least one tower member after the structural adhesive is cured.

4. A method as defined in claim 1, wherein the tower has a polygonal monopole configuration.

5. A method as defined in claim 1, wherein the step of applying includes placing the structural adhesive onto the at least one reinforcing member.

6. A method as defined in claim 1, wherein the step of applying includes placing the structural adhesive onto the at least one tower member.

7. A method as defined in claim 1, further including the step of introducing a spacer interposed between the at least one tower member and the at least one reinforcing member prior to the step of placing.

8. A method as defined in claim 7, wherein the step of introducing a spacer includes mixing glass beads into the structural adhesive.

9. A method as defined in claim 7, wherein the spacer is fabricated from a material including one of plastic, string, and metal.

10. A method as defined in claim 1, further including the step of preparing the at least one tower member for receiving the structural adhesive by one of sanding, sandblasting, and chemical washing.

11. A method as defined in claim 1, further including the step of preparing the at least one reinforcing member for receiving the structural adhesive should the at least one reinforcing member have a galvanizing layer.

12. A method as defined in claim 11, wherein the step of preparing the at least one reinforcing member includes one of cleaning, etching, and removing the galvanizing layer.

13. A method as defined in claim 12, wherein the cleaning, etching, and removing is accomplished by one of chemical and abrasive means.

14. A method as defined in claim 12, wherein the step of preparing the at least one reinforcing member further includes applying a primer.

15. A tower reinforcement system comprising:
a tower including at least one tower member;
at least one reinforcing member coupled to the at least one tower member by structural adhesive; and
at least one elongated fastener to secure the at least one reinforcing member to the at least one tower member while the structural adhesive is curing.

16. A tower reinforcement system as defined in claim 15, wherein the at least one elongated fastener includes bolts.

17. A tower reinforcement system as defined in claim 15, wherein the at least one reinforcing member includes a flat plate reinforcement.

18. A tower reinforcement system as defined in claim 15, wherein the at least one reinforcing member includes a channel reinforcement.

19. A tower reinforcement system as defined in claim 15, wherein the at least one reinforcing member includes a structural tube reinforcement.

20. A tower reinforcement system as defined in claim 19, wherein the at least one elongated fastener includes a bolt to be secured to an outside of the structural tube reinforcement.

21. A tower reinforcement system as defined in claim 19, wherein the at least one elongated fastener includes a bolt to be secured to an inside of the structural tube reinforcement.

22. A tower reinforcement system as defined in claim 15, further including a spacer interposed between the at least one reinforcing member and the at least one tower member.

23. A tower reinforcement system as defined in claim 22, wherein the spacer is made from a material including one of plastic, string, and metal.

24. A tower reinforcement system as defined in claim 22, wherein the spacer includes glass beads mixed with the structural adhesive.

25. A tower reinforcement system as defined in claim 15, wherein the at least one reinforcing member is fabricated from a material including one of a metal, and a fiber reinforced polymer.

26. A tower reinforcement system as defined in claim 25, wherein the metal includes steel.

27. A tower reinforcement system as defined in claim 25, wherein the fiber reinforced polymer includes carbon fibers encapsulated in a resin matrix.

28. A tower reinforcement system as defined in claim 15, wherein the at least one tower member is fabricated from a material including metal.

29. A tower reinforcement system as defined in claim 28, wherein the metal includes steel.
